(19) United States
(12) Patent Application Publication
(10) Pub. No.: US 2026/0195922 A1
(43) Pub. Date: Jul. 9, 2026

(54) CELESTIAL BODY BASED SENSOR CALIBRATION

(71) Applicant: QUALCOMM Incorporated, San Diego, CA (US)

(72) Inventors: Benjamin MESIC, Osijek (HR); Julia KABALAR, München (DE); Kiran BANGALORE RAVI, Paris (FR)

(21) Appl. No.: 19/009,612

(22) Filed: Jan. 3, 2025

(51) Int. Cl. G06T 7/80

(52) U.S. Cl. CPC G06T 7/80; G06T 2207/10004

(57) ABSTRACT

Systems and techniques are described herein for calibrating a sensor. For example, a computing device can process an image of a sky to determine a position of a celestial body in the image. The computing device can determine an expected position of the celestial body and can compare the expected position of the celestial body and the determined position of the celestial body in the image. The computing device can adjust parameters of the sensor based on the comparison.

### FIELD

The present disclosure generally relates to calibration techniques for sensor calibration. For example, aspects of the present disclosure relate to systems and techniques for using position of a celestial body in a sky for sensor (e.g., image sensors such as cameras) calibration.

### BACKGROUND

Sensor capabilities can change as parameters of the sensors change. The change in parameters of sensors (e.g., extrinsic parameters and intrinsic parameters) capabilities of sensors can change as extrinsic and intrinsic parameters of the sensors change. For example, sensors can become de-calibrated based changes to extrinsic and intrinsic parameters of the sensors. Various factors such as temperature, ultraviolet sunlight, movement of the sensor, etc. can cause a sensor to become de-calibrated. Many systems and devices (e.g., autonomous and semi-autonomous vehicle, drones, mobile robots, mobile devices, extended reality (XR) devices, and other systems or devices) include multiple sensors to gather information about the environment. Calibration of sensors is used to ensure accuracy of sensor data as extrinsic and intrinsic parameters of the sensor deviate over time. In the examples of systems and devices that use sensors to control motion of a system (e.g., an autonomous or semi-autonomous vehicle), sensor data accuracy can be crucial to providing a safe and comfortable experience to users.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for calibrating a sensor is provided. The apparatus includes at least one memory and at least one processor coupled to the at least one memory and configured to: process an image of a sky to determine a position of a celestial body in the image; determine an expected position of the celestial body; compare the expected position of the celestial body and the determined position of the celestial body in the image; and adjust parameters of the sensor based on the comparison.

In some aspects, a method for calibrating a sensor is provided. The method includes: processing an image of a sky to determine a position of a celestial body in the image; determining an expected position of the celestial body; comparing the expected position of the celestial body and the determined position of the celestial body in the image; and adjusting parameters of the sensor based on the comparison.

In some aspects, a non-transitory computer-readable medium is provided having stored thereon instructions that, when executed by at least one processor, cause the at least one processor to: process an image of a sky to determine a position of a celestial body in the image; determine an expected position of the celestial body; compare the expected position of the celestial body and the determined position of the celestial body in the image; and adjust parameters of the sensor based on the comparison.

In some aspects, an apparatus for calibrating a sensor is provided. The apparatus includes: means for processing an image of a sky to determine a position of a celestial body in the image; means for determining an expected position of the celestial body; means for comparing the expected position of the celestial body and the determined position of the celestial body in the image; and means for adjusting parameters of the sensor based on the comparison.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

In some aspects, one or more of the apparatuses described herein is, is part of, and/or includes a mobile device (e.g., a mobile telephone or other mobile device), an extended reality (XR) device or system (e.g., a virtual reality (VR) device, an augmented reality (AR) device, or a mixed reality (MR) device), a wearable device, a wireless communication device, a camera, a personal computer, a laptop computer, a vehicle or a computing device or component of a vehicle, a server computer or server device (e.g., an edge or cloud-based server, a personal computer acting as a server device, another device, or a combination thereof. In some aspects, the apparatus(es) can include a camera or multiple cameras for capturing one or more images. In some aspects, the apparatus(es) can include a display for displaying one or more images, notifications, and/or other displayable data. In some aspects, the apparatus(es) can include one or more sensors (e.g., one or more global positioning system (GPS) sensors, one or more global navigation satellite system (GNSS) sensors, one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example device that can generate cylindrical projections from image and perform sensor calibration, in accordance with some examples.

FIG. 3 is a diagram illustrating an example of a vehicle with a sensor suite, according to various aspects of the present disclosure;

FIG. 4 is a block diagram illustrating an example of detecting a celestial body and changes in location of the celestial body, in accordance with some examples.

FIG. 5 is a block diagram illustrating an example system for sensor calibration based on the location of a celestial body, in accordance with some examples.

FIG. 6 is a block diagram of an example system for determining expected celestial body locations, in accordance with some examples.

FIG. 7 is a block diagram of an example system for detecting a celestial body in an image, in accordance with some examples.

FIG. 8 is a flow diagram illustrating an example process for calibrating a sensor, in accordance with some examples.

FIG. 9 is a block diagram illustrating an example neural network, in accordance with some examples.

FIG. 10 is a block diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As mentioned previously, the capabilities of sensors can change as extrinsic and intrinsic parameters of the sensors change. Sensor components can degrade over time affecting sensor calibration. Sensor parameters can include extrinsic parameters and intrinsic parameters. Intrinsic parameters of sensors can include software value representations of the capabilities of the hardware (e.g., capabilities of components of the sensor). Example intrinsic parameters, also referred to as intrinsics, can include skew, focal length, range, resolution, operating temperature, aspect ratio, etc. Extrinsic parameters, also referred to as extrinsics, can include the position, orientation (e.g., pitch, roll, yaw, etc.), pose (e.g., position and orientation), and movement of the sensor. Many systems and devices (e.g., autonomous and semi-autonomous vehicles, drones, mobile robots, mobile devices, extended reality (XR) devices, and other systems or devices) include multiple sensors to gather information about the environment. Calibration of sensors ensures accuracy of sensor data as the accuracy of the extrinsic parameters and intrinsic parameters of sensors deviate over time.

For example, sensors that are part of systems that generally operate in motion (e.g., a semi-autonomous or autonomous vehicle, a mobile robot, drone, etc.) can experience de-calibration resulting from adjustments to a position or orientation of the sensors. For example, an image sensor can be part of a vehicle used for an advanced driver assistance system (ADAS). For example, a sensor can be used for object detection and to determine a distance of the object from the vehicle. An adjustment to the pitch, roll, or yaw of the camera can represent a deviation in an expected angle or position of the camera. The deviation can cause the vehicle to incorrectly determine a distance of the object from the vehicle, affecting the accuracy of the sensor.

In another example, sensors which are part of systems that primarily operate outside can experience thermal cycles resulting from fluctuations in temperature and weather. The thermal cycles can cause the expansion and contraction of components of the system. For example, a bracket attaching a sensor to a vehicle can expand or contract based on the temperature. The numerous expansions and contractions can warp the bracket affecting the position or orientation of the sensor. A change in the position and orientation of the sensor can be represented as a change in extrinsic parameters of the sensor. The change in extrinsic parameters can represent a de-calibration of the sensor and affect the accuracy of sensor data captured by the sensor. Calibration of sensors is important to ensure accuracy of the sensor data as the capabilities of the sensor (e.g., represented by the intrinsic parameters and extrinsic parameters of the sensor) changes. Further, changes in accuracy of a sensor can cause a system (e.g., an autonomous vehicle) to be out of compliance with laws and regulations for safe operation.

Image sensors (e.g., cameras, Light Detection and Ranging (LIDAR) sensors, Radio Detection and Ranging (radar) sensors, etc.) of vehicles can be especially impacted by fluctuations in temperature and adjustments to orientation due to motion. Rough road conditions (e.g., potholes, gravel, speed bumps, etc.) can cause jostling or vibration of cameras that are not securely fastened to the vehicle. Further, vehicles are generally used for long periods of time and are often kept outside. In some environments, temperature conditions can vary 30 or more degrees Fahrenheit within a day and 90 or more degrees Fahrenheit between seasons (e.g., difference between summer high temperatures and winter low temperatures). Image sensors located on an exterior of the vehicle such as parking cameras can be exposed directly to the temperatures affecting the intrinsic parameters of the parking cameras and potentially affecting the extrinsic parameters of the parking camera by affecting components mounting the parking camera to the vehicle. Further, the initial extrinsic and intrinsic parameters of sensors can be suboptimal from an insufficient factory calibration. For example, errors in manufacturing of sensors or assembly of components (e.g., incorrect placement or orientation of sensors) can affect sensor calibration.

In some examples, data from sensors can be fused with or used in conjunction with data received from various services and sources. For example, systems such as vehicles can receive data from a high definition (HD) map. HD maps can be used by vehicles (e.g., autonomous and/or semi-autonomous vehicles) for various purposes, including navigation, scene understanding, etc. For instance, an HD map encodes prior knowledge of scenes (e.g., environment) that a vehicle may encounter. An HD map may be three-dimensional (e.g., including elevation information). For instance, an HD map may include three-dimensional data (e.g., elevation data) regarding a three-dimensional space, such as a road on which a vehicle is navigating. In some examples, the HD map can include a plurality of map points corresponding to one or more reference locations in the three-dimensional space. In some cases, the HD map can include dimensional information for objects in the three-dimensional space and other semantic information associated with the three-dimensional space. For instance, the information from the HD map can include elevation or height information (e.g., road elevation/height), normal information (e.g., road normal), and/or other semantic information related to a portion (e.g., the road) of the three-dimensional space in which the vehicle is navigating.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. The semantic information about the environment may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

For a vehicle (e.g., an autonomous or semi-autonomous vehicle) to utilize HD maps, the vehicle must determine its own position (location) in relation to the HD map. An autonomous vehicle typically utilizes positioning sensors implemented onboard the vehicle to estimate a location of the vehicle. The positioning sensors can include satellite receivers (e.g., for satellite positioning systems) and inertial measurement units (IMUs).

Systems, apparatuses, methods (also referred to as processes), and computer-readable media (collectively referred to herein as “systems and techniques”) are described herein that provide calibration techniques for parameters (e.g., intrinsic parameters and extrinsic parameters) of sensors. In some aspects, the systems and techniques can include receiving an image or generating an image using an image sensor. For example, the systems and techniques can be included in a vehicle (e.g., an autonomous vehicle or semi-autonomous vehicle) including a camera. In some aspects, the image can include a visual representation of the sky. For example, the image sensor can be part of a vehicle for performing object detection for autonomous or semi-autonomous operation of the vehicle. In such an example, the image sensor can generate images of a road and the surrounding environment including the sky.

In some aspects, the systems and techniques can include detecting a celestial body (e.g., the moon, the sun, etc.) from the image including the sky (also referred to as the image of the sky). In some examples, detecting the celestial body from the image including the sky can be performed by a celestial body detection engine. In some examples, the celestial body detection engine is a machine learning model trained to perform object detection. In further examples, the systems and techniques can include detection of one or more celestial bodies using luminance detection in a luminance channel of an image sensor. In some examples, detecting the celestial bodies can include filtering false positives of bright spots in an image (e.g., streetlights, traffic lights, headlights, etc.). In some examples, the filtering can be based on a time of day. In such an example, the systems and techniques can filter out detection of the sun during times of day where the sun has set (e.g., filtering detection of the sun in images generated after 9:00 PM or before 4:00 AM, etc.).

In some aspects, the systems and techniques can include detecting celestial bodies using computer vision models. For example, the systems and techniques can include detecting the celestial bodies in an image based on pixel intensity of the image (e.g., light intensity associated with pixels). In some examples, the systems and techniques can filter false positives detections of celestial bodies based on location of the detection within an image. For example, an image sensor (e.g., a camera) can be mounted on a vehicle for detecting objects on a road. In such an example, the bottom half on images generated by the image sensor can be of the road, and the top half of the images are associated with the sky. The systems and techniques can include filtering false positive detections based on location within the image (e.g., when a false positive indicates the celestial body as not being in the sky such as on the road).

In some aspects, the systems and techniques can include detecting the celestial body in a plurality of images. For example, the image sensor can be a camera generating a series of images such as a video. The systems and techniques can include filtering false positives from the series images based on an unexpected movement of an object incorrectly determined to be a celestial body. For example, when the systems and techniques include a false positive of a streetlight as being the moon, the systerms and techniques can filter the false positive based on movement of the streetlight in a video as the image sensor moves past the streetlight (e.g., tracking pixels having a light intensity greater than a predetermined value when the image sensor is in motion).

In some aspects, the systems and techniques can include receiving information (e.g., data) associated with an expected location of celestial bodies. For example, the systems and techniques can include receiving the expected location of a celestial body from an HD map. For example, the HD map can include information associated with the location of celestial bodies such as azimuth angles of celestial bodies from an image sensor or system including the image sensor.

In some aspects, the systems and techniques can generate one or more synthetic images (also referred to as an estimated image) associated with the expected position or expected location of a celestial body (e.g., an image including a visual representation of the celestial body at an expected position in the sky from a perspective of the image sensor) based on received data (e.g., data received from the HD map indicating the expected location of the celestial body in the sky). The systems and techniques can include comparing one or more synthetic images associated with the expected location of the celestial body to one or more images including a visual representation of the celestial body generated by an image sensor.

The systems and techniques can include updating parameters of the image sensor based on deviations in the synthetic images and the images generated by the image sensor. For example, a deviation in the position of a celestial body in a synthetic image and the position of the celestial body in the image generated by the image sensor can indicate a change in pose of the image sensor from an expected pose of the image sensor. For example, the image sensor can be moved adjusting a pitch, roll, or yaw of the image sensor from an expected pitch, roll, or yaw. The deviation in the position of the celestial body in the synthetic image from the image generated by the image sensor can be used to determine an updated pitch, roll, or yaw of the sensor. For example, a deviation where the celestial body in the synthetic image is positioned left of the celestial body in the image generated by the image sensor can indicate that the image sensor is tilted right of an expected pose of the image sensor. The systems and techniques can include updating a variable associated with parameters of the image sensor associated with the change in parameters. For example, when the deviation between position of the celestial body in the synthetic image and the image generated by the image sensor indicates the image sensor is tilted, the system and techniques can include updating a variable associated with the roll, pitch, or yaw of the image sensor.

Various parameters (e.g., extrinsic parameters or intrinsic parameters) can be determined from deviations in the synthetic image and the image generated by the image sensor. For example, the systems and techniques can include determining a change in focal length or principal point of a camera based on warping or movement of a lens. The systems and techniques can include determining a change in parameters such as the focal length or principal point based on distortions or movement of a celestial body in images when compared to a synthetic image.

In some aspects, the systems and techniques can include generating directions to a road to perform calibration of a sensor using the images of the celestial body. For example, the HD map can include predetermined locations for calibrating the sensors. For example, the predetermined locations can be locations providing a clear (e.g., non-occluded) view of the sky. The predetermined locations can be associated with a consistent elevation (e.g., a substantially flat, straight road providing a non-occluded view of the sky. In some examples, the systems and techniques can direct a vehicle to the predetermined location for sensor calibration. In further examples, the systems and techniques can automatically perform sensor calibration (e.g., celestial body detection and image comparison) when the sensor is located at the predetermined location. In further examples, the systems and techniques can include receiving a destination from a user, generating directions to the destination, and determining a location along a route to the destination at which to calibrate the sensor. For example, the HD map can include elevation data associated with roads. The systems and techniques can include determining to perform sensor calibration on a road of near constant elevation (e.g., a substantially flat road).

Various aspects of the present disclosure will be described with respect to the figures.

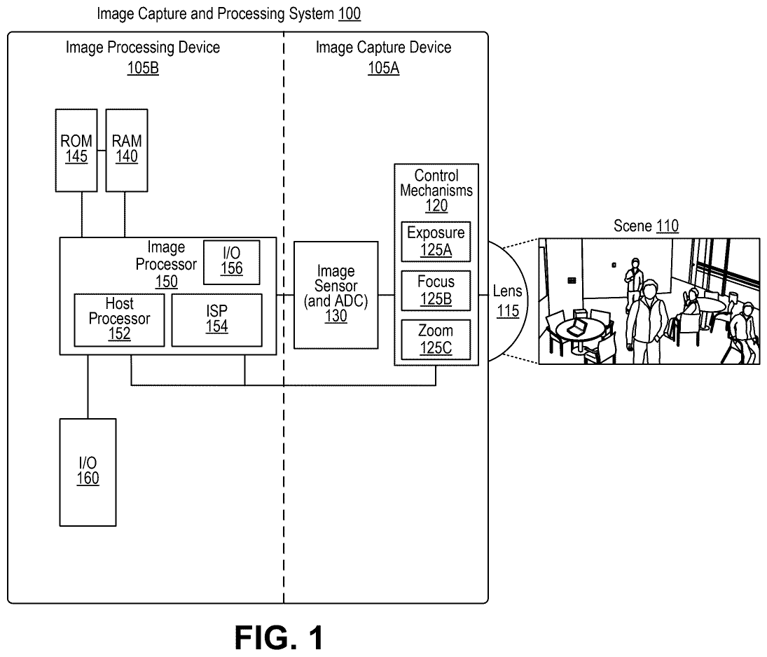

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses can be included in the image capture and processing system 100, such as one or more microlenses over each photodiode of the image sensor 130, which each bend the light received from the lens 115 toward the corresponding photodiode before the light reaches the photodiode. The focus setting can be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image capture and processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective covers that block light from reaching certain photodiodes, or portions of certain photodiodes, at certain times and/or from certain angles. In some cases, opaque and/or reflective covers may be used for phase detection autofocus (PDAF). In some cases, the opaque and/or reflective covers may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

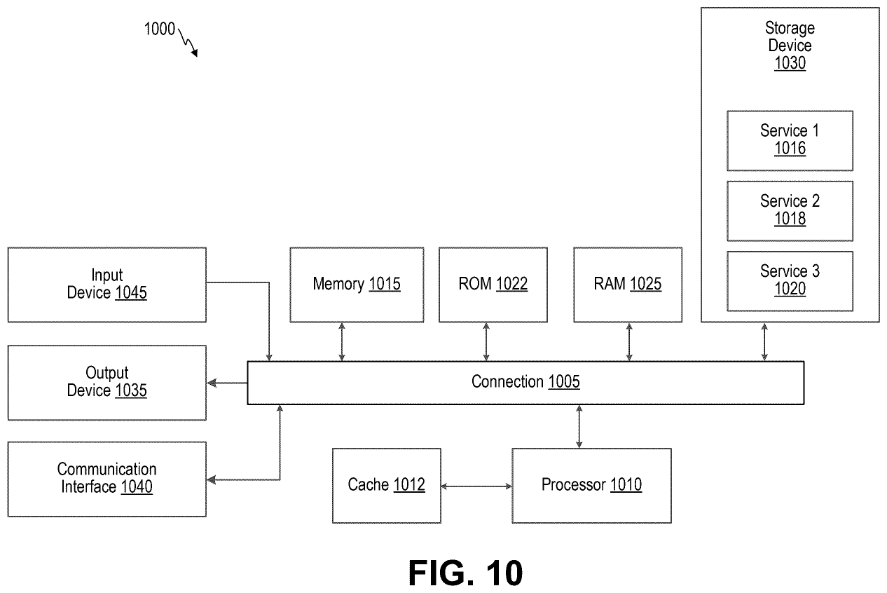

The image processor 150 may include one or more processors, such as one or more image signal processors (ISPs) (including ISP 154), one or more host processors (including host processor 152), and/or one or more of any other type of processor 1010 discussed with respect to the computing-device architecture 1000 of FIG. 10. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

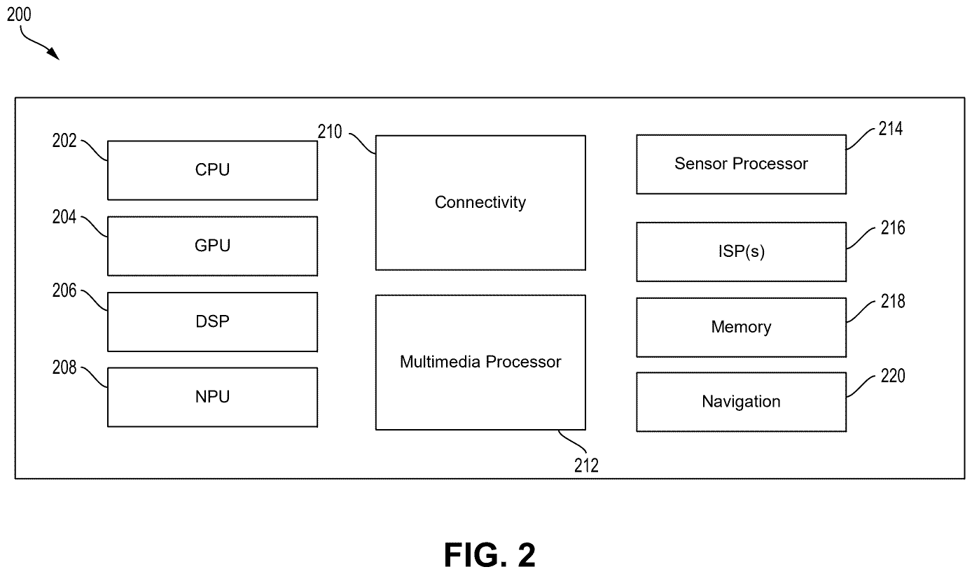

In some examples, the system-on-a-chip (SOC) 200 of FIG. 2 can include the image capture and processing system 100, the image capture device 105A, the image processing device 105B, or a combination thereof.

FIG. 2 illustrates an example implementation of a system-on-a-chip (SOC) 200, which may include a central processing unit (CPU) 202 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 208, in a memory block associated with a CPU 202, in a memory block associated with a graphics processing unit (GPU) 204, in a memory block associated with a digital signal processor (DSP) 206, in a memory block 218, and/or may be distributed across multiple blocks. Instructions executed at the CPU 202 may be loaded from a program memory associated with the CPU 202 or may be loaded from a memory block 218.

The SOC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, DSP 206, and/or GPU 204. The SOC 200 may also include a sensor processor 214, image signal processors (ISPs) 216, and/or navigation module 220, which may include a global positioning system.

The SOC 200 may be based on an ARM instruction set. SOC 200 and/or components thereof may be configured to perform segmentation mask extrapolation. For example, the CPU 202, DSP 206, and/or GPU 204 may be configured to perform object detection (e.g., detection of celestial bodies in an image) using a machine learning model (e.g., the neural network described in the description of FIG. 10).

In some cases, the SOC 200 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

In some cases, sensor data, such as images captured by the image capture and processing system 100, point clouds captured by LIDAR/RADAR sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics. Further description of a neural network is provided in the description of FIG. 10.

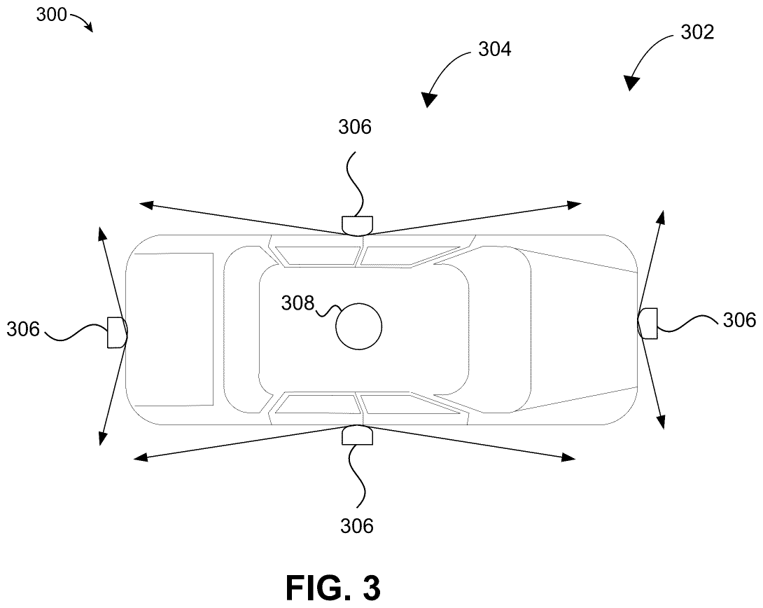

FIG. 3 is a diagram illustrating an example of a vehicle (e.g., an autonomous vehicle) 302 with a sensor suite 304. The source sensor suite 304 is shown to include four cameras 306 and one Light Detection and Ranging (LIDAR) sensor 308. Each of the cameras 306 may be a surround view (SV) camera or a fisheye camera, for example, with a wide (e.g., nearly 180 degree) field of view. The LIDAR sensor 308 may be a 64-layer LIDAR sensor. In one or more examples, the source sensor suite 304 of the source vehicle 302 may include a greater or lower number of cameras 306 and/or LIDAR sensors 308, than as shown in FIG. 3.

Collectively, the source sensor suite 304 may have certain intrinsic parameters (e.g., focal lengths of the cameras 306, optical centers of the cameras 306, skew coefficients of the cameras 306, frame-capture rates of the cameras 306, scan patterns of the LIDAR sensor 308, and/or intensity channels of the LIDAR sensor 308 or the cameras 306) and certain extrinsic parameters (e.g., positions of the cameras 306 and the LIDAR sensor 308 on source vehicle 302).

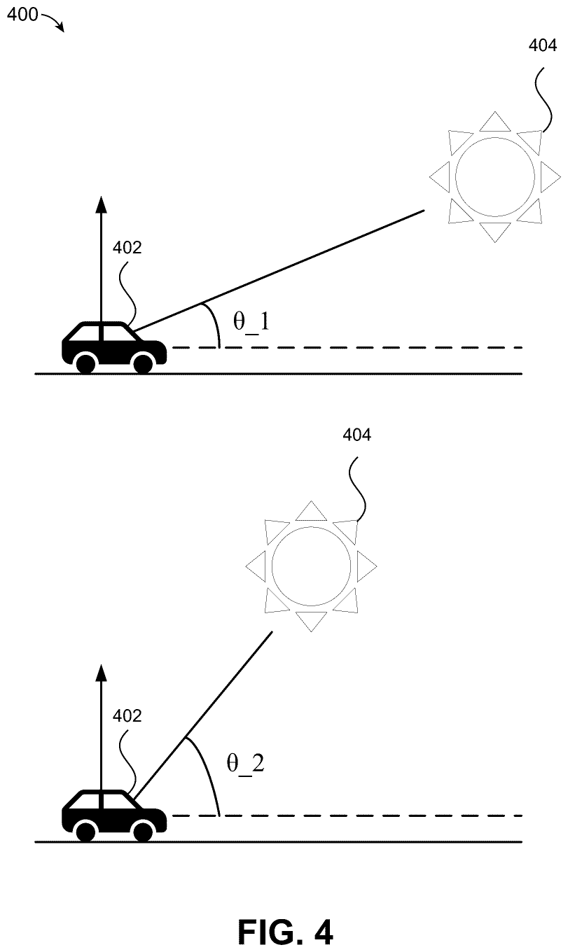

Data from at least a portion of the source sensor suite 304 may be used to identify or track celestial bodies (e.g., the sun, the moon, etc.) in an image captured by image sensors (e.g., cameras) of the source sensor suite 304. The data from the portion of the source sensor suite 304 can be used to calibrate one or more image sensors, as further described in the description of FIG. 4-FIG. 8.

As previously mentioned, increasingly systems and devices (e.g., autonomous vehicles, such as autonomous and semi-autonomous vehicles, drones, mobile robots, mobile devices, extended reality (XR) devices, and other suitable systems or devices) employ multiple sensors (e.g., camera sensors) to gather information about the environment, as well as processing systems to process the information gathered, such as for route planning, navigation, collision avoidance, environment modelling/rendering, etc.

In one or more aspects, the systems and techniques provide on-line and on-device sensor calibration. In some aspects, sensors of the source sensor suite 304 can be calibrated without requiring the sensor be returned to manufacturer, dealership, retailer, mechanic, etc. In some examples, one or more camera sensors of the device can obtain the one or more images of the environment of the device. In one or more examples, the device may determine a subset of camera sensors of the one or more camera sensors for the one or more regions of the at least one first image based on: the subset of camera sensors having views within which the one or more objects are centrally located (e.g., more centrally located as compared to the location of the one or more objects within one or more views of one or more other camera sensors), the subset of camera sensors having views when the one or more objects are least occluded as compared to views of other camera sensors of the one or more camera sensors, and/or machine learning training for selecting the subset of the camera sensors.

In one or more examples, the image capture and processing system 100 of FIG. 1 can be one of the sensors of the source sensor suite 304 of FIG. 3. In such an example, the image capture and processing system 100 or the SOC 200 of FIG. 2 can process images generated by a camera or image sensor of FIG. 1 or FIG. 3 to detect a celestial body from the image. The autonomous vehicle 300 can perform sensor calibration on-line (e.g., during operation of the sensor or autonomous vehicle 300) or offline (e.g., after the autonomous vehicle 300 has reached a destination or is not in use).

FIG. 4 is a block diagram illustrating an example 400 of detecting a celestial body and changes in location of the celestial body. FIG. 4 includes a vehicle 402 (e.g., the vehicle 300 of FIG. 3) and a celestial body 404. The celestial body can include the sun and the moon. The vehicle 402 can include a sensor (e.g., cameras or image sensors) for performing various ADAS or autonomous driving operations. By way of example, the celestial body (e.g., in this example the sun) is visible at different locations in the sky based on a time and date. For example, the sun can be visible at different locations in the sky depending on a season of the year and time of day (e.g., sun rising in the east at the start of the day for 0 degrees or 180 degrees depending on perspective of the vehicle 402, being visible substantially 90 degrees above the vehicle 402, and setting in the west at the end of the day 180 degrees or 0 degrees depending on perspective of the vehicle 402). In some examples, the position of celestial bodies can be represented as azimuth angles (e.g., horizontal angle from a cardinal direction).

The change in visible position of the celestial body 404 in the sky can be represented as a change in angle from the vehicle 402 to the celestial body 404. For example, as the visible location of the celestial body 404 changes, the angle from a sensor of the vehicle 402 to the celestial body 404 can change. In examples in which the sensor is a camera or image sensor, the change in angle can be visible as a change in location of the celestial body in images generated by the sensor. For example, an image generated by the sensor at sun rise can include visual representation of the sun at a lower section of the image than an image generated by the sensor in the afternoon.

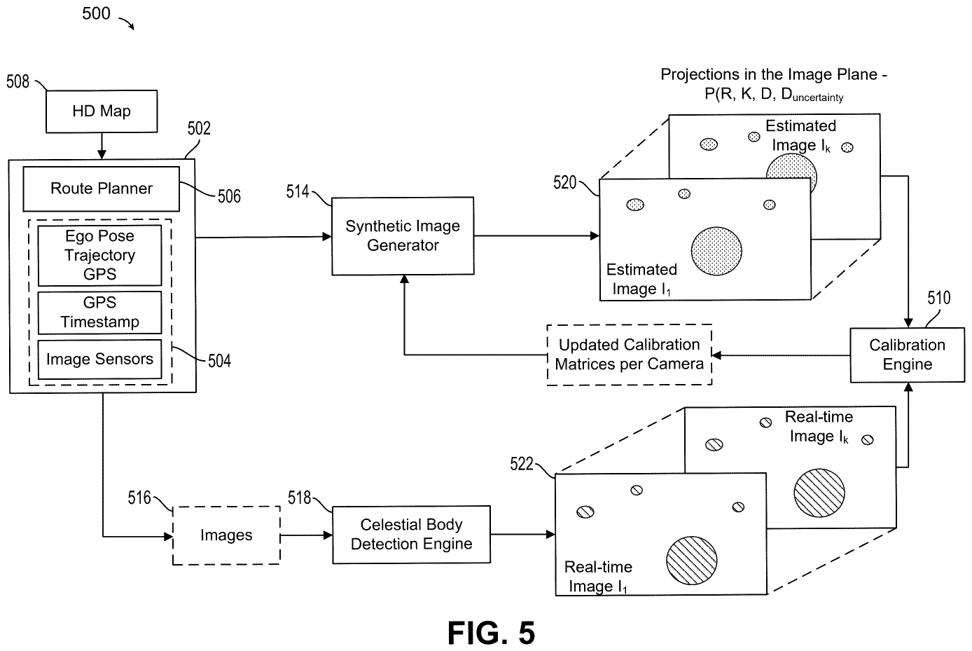

FIG. 5 is an example system 500 for sensor calibration based on the location of a celestial body. The system 500 includes a vehicle 502 (e.g., the vehicle 300 of FIG. 3). The vehicle 502 can include a sensor suite 504 and a route planner 506. The vehicle 502 can receive data from various services or applications, such as an HD map 508. The system 500 can further include a celestial body detection engine 518, a calibration engine 510, and a synthetic image generator 514. The celestial body detection engine 518, the calibration engine 510, and the synthetic image generator 514 can be a component of the vehicle 502 or can be executed on a processor or computing device of the vehicle 502 such as the SOC 200 of FIG. 2.

The sensor suite 504 (e.g., the sensor suite 304 of FIG. 3) can include one or more image sensors such as cameras. In some examples, the sensor suite 504 For example, the camera can be a 360 view camera to detect objects in an environment including the sky. The sensor suite 504 can include various other sensors include inertial measurement units such as an accelerometer to track the vehicle 502 pose and trajectory direction. The sensor suite can include a Global Navigation Satellite System (GNSS) such as a global positioning system (GPS) or other satellite tracking system. In some examples, the GNSS can be part of the route planner 506.

The HD map 508 can include celestial body angle data associated with azimuth angles of the celestial bodies from an object on the surface of the Earth to the celestial body. The azimuth angles can indicate the position of the celestial body in the sky. For example, an azimuth angle receiving the expected location of a celestial body from an HD map. For example, the HD map can include information associated with the location of celestial bodies such as azimuth angles of celestial bodies from an image sensor or system including the image sensor. The azimuth angles associated with the celestial body be based on a time, date, and location of the vehicle 502. In some examples, the vehicle 502 can receive celestial body angle data from an application or service tracking the celestial body.

The system 500 can use the route planner 506 to direct the vehicle 502 to a location for calibrating one or more sensors from the sensor suite 504. For example, the route planner 506 can receive information from the HD map 508 indicating a location with substantially constant elevation and a clear view of the sky (e.g., a substantially flat, straight, and clear road). The route planner 506 can direct the vehicle 502 to the location to perform sensor calibration. In some examples, the route planner 506 can receive information from the HD map 508 indicating a location along a route to perform sensor calibration. For example, a user can select a destination. The route planner 506 can determine a location along the route to the destination to perform sensor calibration based on HD map data. The system 500 can perform sensor calibration when the vehicle 502 is at the location.

Image sensors of the sensor suite 504 can generate images 516 of an environment including the sky. For example, the image sensors can be oriented to generate images associated with operating the vehicle 502 (e.g., images of the road for object detection, images of traffic lights for autonomous driving, etc.). In the images generated by the image sensors, the sky can be visible in sections of the images. The images including a visual representation of the sky can be provided to the celestial body detection engine 518.

The celestial body detection engine 518 can detect a celestial body (e.g., the sun or the moon) from the images 516. For example, the celestial body detection engine 518 can process the images 516 to identify pixels with a light intensity value exceeding a predetermined threshold. For example, light from the sun or the moon can be associated with predetermined light intensity threshold or range of light intensity values. When the celestial body detection engine 518 detects pixels exceeding the light intensity threshold, the celestial body detection engine 518 can determine a celestial body is present in the image. In some examples, the celestial body detection engine 518 can use a plurality of images such as a video to filter false positives of celestial body detections.

For example, the celestial body detection engine 518 can detect a streetlight and incorrectly identify light from the streetlight as being a celestial body. In such an example, the celestial body detection engine 518 can filter out the detection of the streetlight based on the movement of the visual location in the streetlight across multiple images. For example, the celestial body detection engine 518 can determine the streetlight is not a celestial body based on the streetlight moving across a plurality of images (e.g., a celestial body is far enough away that movement of the vehicle will not cause shifts in the position of the celestial body across a sequence of images whereas an object closer to the image sensor will move within a sequence of images as the vehicle passes the object). In some examples, the celestial body detection engine 518 can receive velocity and acceleration information associated with the vehicle 502 to filter out images generated as the vehicle 502 is turning or adjusting elevation above an elevation threshold.

In some examples, the celestial body detection engine 518 can output a subset of the received images 516. The subset of images (represented by real-time images 522, including images I₁ through Iₖ, where k can be a value equal to or greater than 0) can include images with a celestial body visible. In some examples, the subset of images can be processed (e.g., using the celestial body detection engine 518) to remove portions of the images. In another example, the subset of images can be processed to include an outline representation of the location of the celestial body, such as to remove occlusions of the image blocking portions of the celestial body.

The system 500 can generate synthetic images using the synthetic image generator 514. The synthetic image generator 514 can use the celestial body angle data to determine an area within an image generated by an image sensor of the vehicle 502 the celestial body should be located (e.g., the expected location of the celestial body). The synthetic image generator 514 can generate the synthetic image based on expected parameters of the sensor (e.g., expected intrinsic parameters and expected extrinsic parameters). For example, the image sensor can include expected extrinsic parameters represented as a rotation matrix associated with a pitch, roll, and yaw of the image sensor. The image sensor can include a translation matrix associated with a position of the image sensor. In further examples, the image sensor can include an intrinsic parameter matrix associated with intrinsic parameters of the image sensor such as focal length, principal point, etc. The synthetic image generator 514 can generate synthetic images 520 (including synthetic images I₁ through Iₖ, where k can be a value equal to or greater than 0) based on expected parameters of the image sensor (e.g., an expected roll, pitch, yaw, etc.). The synthetic image generator 514 can generate synthetic images 520 associated with the time, date, and location of the subset of images (e.g., the real-time images 522) generated by the image sensor.

The calibration engine 510 can compare the subset of images (e.g., the real-time images 522) to synthetic images 520. For example, the calibration engine 510 can compare positions of the celestial body in multiple real-time images 522 and the synthetic images 520 to determine deviations between the images. The calibration engine 510 can determine updated sensor parameters based on deviations between the synthetic images and the real-time images 522. For example, the calibration engine 510 can adjust values associated with extrinsic parameters and intrinsic parameters to determine a set of parameters causing the synthetic image generator 514 to generate a synthetic image 520 which substantially matches the location of the celestial body in the real-time image 522.

For example, the calibration engine 510 can be an algorithm to iterate through changes to an extrinsic parameter matrix or intrinsic parameter matrix to generate a substantially matching synthetic image (e.g., a synthetic image which includes the celestial body at a position matching the position of the celestial body represented in an image generated by an image sensor). In further examples, the calibration engine can be a machine learning model trained to determine adjustments to parameters of image sensors based on differences in the synthetic images 520 and the real-time images 522. In another example, the calibration engine 510 can calibrate the sensor over multiple trajectories (e.g., multiple sequences of images). The calibration can be performed using various optimization methods such as manifold optimization methods.

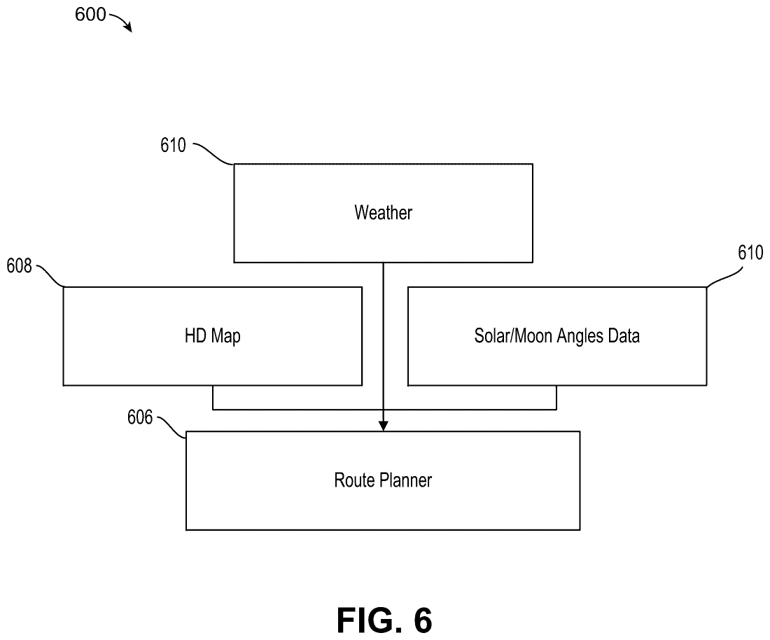

FIG. 6 is a block diagram 600 illustrating an example route planner 606 (e.g., the route planner 506 of FIG. 5). The route planner 606 can include GNSS receivers or GNSS transceivers used to determine a location of a vehicle including the route planner 606. The route planner 606 can receive an input representing a destination. The route planner 606 can generate directions to the destination. In some examples, the route planner 606 can generate directions to a location to calibrate a sensor. For example, the route planner 606 can receive road information (e.g., HD map data) from an HD map 508 associated with a predetermined road that is substantially flat and substantially straight. The route planner 606 can direct the vehicle to the predetermined road for the vehicle (or component thereof) to perform sensor calibration when operating on the road.

In some examples, the route planner 606 can receive weather information, such as weather information from a weather service 610. For example, the route planner can determine not to direct the vehicle to a location for sensor calibration based on the weather. For example, the route planner can determine not to direct the vehicle to a location for sensor calibration on a day when clouds may be occluding celestial bodies (e.g., clouds covering the sun or moon). In some examples, the route planner 606 can receive celestial body angles (e.g., azimuth angles) associated with the position of the celestial body in the sky at a time and date from a tracking application or tracking service 612.

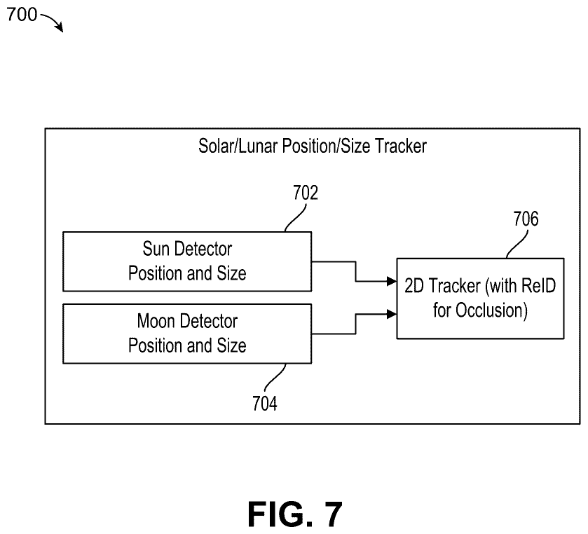

FIG. 7 is a block diagram illustrating an example celestial body tracker 700. The celestial body tracker 700 can be part of a synthetic image generator such as the synthetic image generator 514 the celestial body detection engine 518 of FIG. 5. The celestial body tracker 700 can detect a celestial body (e.g., the sun or the moon) from images. For example, the celestial body tracker can include detection engines (e.g., sun detection engine 702 and moon detection engine 704) to detect the sun or the moon in images. The detection engines can process the images to identify pixels with a light intensity value exceeding a predetermined threshold. For example, light from the sun or the moon can be associated with predetermined light intensity threshold or range of light intensity values. The detection engines can determine the sun, or the moon is represented in the image based on pixels of the images exceeding the light intensity threshold. In some examples, the detection engines can use a plurality of images such as a video to filter false positives of celestial body detections.

For example, the detection engines can detect headlights from another vehicle and incorrectly identify light from the headlights as a celestial body. The detection engines can filter the detection of the headlights based on movements of the headlights across multiple images. The celestial body tracker can include a two-dimensional (2D) tracker 706 to track the celestial body when images of the celestial body are occluded. For example, by tracking celestial bodies across images with occlusions, the celestial body tracker 700 can track celestial bodies across a sequence of images without having to use the detection engines to redetect the celestial bodies after processing an image with occlusions over the celestial bodies.

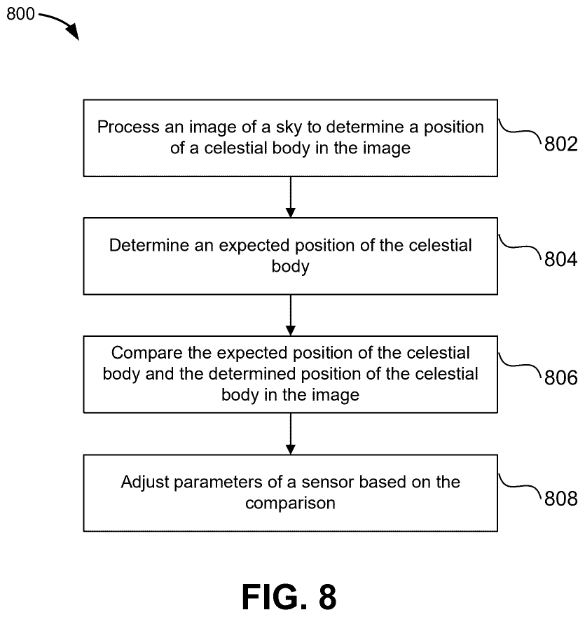

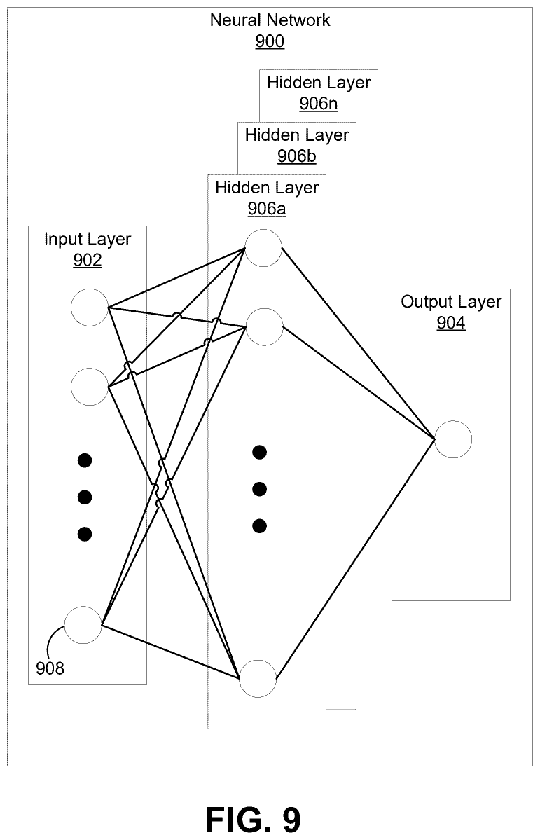

FIG. 8 is a flow diagram illustrating an example of a process 800 for adjusting sensor parameters (e.g., to calibrate a sensor or otherwise adjust parameters of the sensor) based on a location of a celestial body. The process 800 can be performed by a computing device (e.g., image and processing system 100 of FIG. 1, SOC 200 of FIG. 2, a computing device including system 500 of FIG. 5, computing device or computing-device architecture 1000 of FIG. 10, etc.) or by a component or system (e.g., the neural network of FIG. 9, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 1010 of FIG. 10 or other processor(s)) of the computing device. Further, the transmission and reception of signals by the computing device in the process 800 can be enabled, for example, by one or more antennas and/or one or more transceivers (e.g., wireless transceiver(s)).

At block 802, the computing device (or component thereof) can process an image of a sky to determine a position of a celestial body in the image. In some examples, the computing device can include a sensor to generate the image (e.g., a camera). In such an example, the computing device can include a sensor oriented to generate an image of the sky around the computing device (or component thereof). In some examples, the computing device can process the image using a machine learning model or a detection engine (e.g., a celestial body detection engine 518 of FIG. 5, the neural network 900 of FIG. 9, etc.) to detect a celestial body within an image. In some examples, the celestial bodies can include the sun, the moon, planets, or stars.

At block 804, the computing device (or component thereof) can determine an expected position of the celestial body. For example, the computing device can determine the expected position of the celestial body based on a time, a date, and a pose of a sensor. For example, the sensor can be the sensor generating the image processed by the computing device (or component thereof). The pose of the sensor can include information such as the position and orientation (e.g., pitch, roll, yaw, etc.) of the sensor. In some examples, the computing device (or component thereof can determine the expected position of the celestial body based on a high definition (HD) map. For example, the HD map can include information associated with the position of celestial bodies at time, dates, and locations. In such an example, the HD map can include information such as the position of the sun in the sky at a particular time and date.

At block 806, the computing device (or component thereof) can compare the expected position of the celestial body and the determined position of the celestial body in the image. In some examples, the computing device (or component thereof) can compare the expected position of the celestial body and the determined position of the celestial body in the image using a machine learning model (e.g., the neural network 900 of FIG. 9). In some aspects, the computing device (or component thereof) to generate an estimated image indicating the expected position of the celestial body. In further aspects, the computing device (or component thereof) the comparison of the expected position of the celestial body and the determined position of the celestial body in the image includes a comparison of the estimated image and the image of the sky.

At block 808, the computing device (or component thereof) can adjust parameters of the sensor based on the comparison. For example, the computing device can adjust extrinsics of the sensor based on the comparison. In such an example, the extrinsics of the sensor can include a position and orientation (e.g., pitch, roll, and yaw) of the sensor.

In some aspects, the computing device (or component thereof) can determine to adjust the parameters of the sensor based on at least one of a temperature of the, a vibration of the apparatus, or a collision of the computing device or the sensor. In such an example, the computing device can be triggered to adjust the parameters of the sensor based on the temperature of the computing device. In another example, the computing device can be triggered to adjust the parameters of the sensor based on a detected change in orientation of the sensor, such as an adjustment to orientation of the sensor from a vibration or a collision. In a further example, the computing device (or component thereof) can determine to adjust the parameters of the sensor based on the location of the sensor on a predetermined road. For example, the computing device can receive location data associated with the location of the computing device (or component thereof such as the sensor). The computing device can determine, when the computing device is at a predetermined location (e.g., the predetermined road), to adjust parameters of the sensor.

As noted previously, one or more of the systems and techniques described herein can be implemented using a neural network. FIG. 9 is an illustrative example of a neural network 900 (e.g., a deep-learning neural network) that can be used to implement machine-learning based sensor calibration based on the location of a celestial body in an image. For example, neural network 900 can be an example of, or can implement, the calibration engine 510 of FIG. 5, the synthetic image generator 514 of FIG. 5, or the celestial body detection engine 518 of FIG. 5.

An input layer 902 includes input data. In one illustrative example, input layer 902 can include data representing data associated with the real-time images 522 of FIG. 5. Neural network 900 includes multiple hidden layers, for example, hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can generate intrinsic parameters or extrinsic parameters to adjust parameters of a sensor. In another illustrative example, output layer 904 can output synthetic images associated with an expected location of a celestial body.

Neural network 900 can be or can include a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target-output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

FIG. 10 illustrates an example computing-device architecture 1000 of an example computing device which can implement the various techniques described herein. In some examples, the computing device can include a vehicle (or computing device of a vehicle), a mobile device, a wearable device, an extended reality device, a personal computer, a laptop computer, a video server, or other device. For example, the computing-device architecture 1000 can include, implement, or be included in any or all of the image and processing system 100 of FIG. 1, SOC 200 of FIG. 2, the vehicle 300 of FIG. 3, the system 500 of FIG. 5, the neural network 900 of FIG. 9, and/or other devices, modules, or systems described herein. Additionally, or alternatively, computing-device architecture 1000 may be configured to perform process 800, and/or other process described herein.

The components of computing-device architecture 1000 are shown in electrical communication with each other using connection 1005, such as a bus. The example computing-device architecture 1000 includes a processing unit (CPU or processor) 1002 and computing device connection 1005 that couples various computing device components including computing device memory 1015, such as read only memory (ROM) 1022 and random-access memory (RAM) 1025, to processor 1010.

Computing-device architecture 1000 can include a cache of high-speed memory connected directly with, in close proximity to, or integrated as part of processor 1010. Computing-device architecture 1000 can copy data from memory 1015 and/or the storage device 1030 to cache 1012 for quick access by processor 1010. In this way, the cache can provide a performance boost that avoids processor 1010 delays while waiting for data. These and other modules can control or be configured to control processor 1010 to perform various actions. Other computing device memory 1015 may be available for use as well. Memory 1015 can include multiple different types of memory with different performance characteristics. Processor 1010 can include any general-purpose processor and a hardware or software service, such as service 1 1016, service 2 1018, and service 3 1020 stored in storage device 1030, configured to control processor 1010 as well as a special-purpose processor where software instructions are incorporated into the processor design. Processor 1010 may be a self-contained system, containing multiple cores or processors, a bus, memory controller, cache, etc. A multi-core processor may be symmetric or asymmetric.

To enable user interaction with the computing-device architecture 1000, input device 1045 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1030 can include services 1016, 1018, and 1020 for controlling processor 1010. Other hardware or software modules are contemplated. Storage device 1030 can be connected to the computing device connection 1005. In one aspect, a hardware module that performs a particular function can include the software component stored in a computer-readable medium in connection with the necessary hardware components, such as processor 1010, connection 1005, output device 1035, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspects 1: An apparatus for adjusting sensor parameters, the apparatus comprising: at least one memory; and at least one processor coupled to the at least one memory and configured to: process an image of a sky to determine a position of a celestial body in the image; determine an expected position of the celestial body; compare the expected position of the celestial body and the determined position of the celestial body in the image; and adjust parameters of a sensor based on the comparison.

Aspect 2: The apparatus of Aspect 1, wherein the at least one processor is configured to: generate an estimated image indicating the expected position of the celestial body; and wherein the comparison of the expected position of the celestial body and the determined position of the celestial body in the image includes a comparison of the estimated image and the image of the sky.

Aspect 3: The apparatus of any of Aspects 1 to 2, wherein the at least one processor is configured to: determine to adjust the parameters of the sensor based on at least one of a temperature of the apparatus, a vibration of the apparatus, or a collision of the apparatus.

Aspect 4: The apparatus of any of Aspects 1 to 3, wherein the at least one processor is configured to: determine the expected position of the celestial body based on a time, a date, and a pose of the sensor.

Aspect 5: The apparatus of any of Aspects 1 to 4, wherein the at least one processor is configured to: determine the expected position of the celestial body based on high definition (HD) map data.

Aspect 6: The apparatus of any of Aspects 1 to 5, wherein the sensor includes a camera.

Aspect 7: The apparatus of any of Aspects 1 to 6, wherein the parameters of the sensor include at least one of a pitch, a roll, or a yaw of the sensor.

Aspect 8: The apparatus of any of Aspects 1 to 7, generate directions to a predetermined road; and generate the image of the sky based on a location of the sensor on the predetermined road.

Aspect 9: The apparatus of any of Aspects 1 to 8, wherein the at least one processor is configured to: determine to adjust the parameters of the sensor based on the location of the sensor on the predetermined road.

Aspect 10: The apparatus of any of Aspects 1 to 9, wherein the celestial body is at least one of a sun or a moon.

Aspect 11: A method for adjusting sensor parameters, the method comprising: processing an image of a sky to determine a position of a celestial body in the image; determining an expected position of the celestial body; comparing the expected position of the celestial body and the determined position of the celestial body in the image; and adjusting parameters of a sensor based on the comparison.

Aspect 12: The method of Aspect 11, further comprising: generating an estimated image indicating the expected position of the celestial body; and wherein the comparison of the expected position of the celestial body and the determined position of the celestial body in the image includes a comparison of the estimated image and the image of the sky.

Aspect 13: The method of any of Aspects 11 to 12, further comprising: determining to adjust the parameters of the sensor based on at least one of a temperature of the sensor, a vibration of the sensor, or a collision of the sensor.

Aspect 14: The method of any of Aspects 11 to 13, further comprising: determining the expected position of the celestial body based on a time, a date, and a pose of the sensor.

Aspect 15: The method of any of Aspects 11 to 14, further comprising: determining the expected position of the celestial body based on high definition (HD) map data.

Aspect 16: The method of any of Aspects 11 to 15, wherein the sensor includes a camera.

Aspect 17: The method of any of Aspects 11 to 16, wherein the parameters of the sensor include at least one of a pitch, a roll, or a yaw of the sensor.

Aspect 18: The method of any of Aspects 11 to 17, further comprising: generating directions to a predetermined road; and generating the image of the sky based on a location of the sensor on the predetermined road.

Aspect 19: The method of any of Aspects 11 to 18, further comprising: determining to adjust the parameters of the sensor based on the location of the sensor on the predetermined road.

Aspect 20: The method of any of Aspects 11 to 19, wherein the celestial body is at least one of a sun or a moon.

Aspect 21. A non-transitory computer-readable medium having stored thereon instructions that, when executed by at least one processor, cause the at least one processor to perform one or more of operations according to any of Aspects 11 to 20.

Aspect 22. An apparatus for adjusting sensor parameters, the apparatus comprising one or more means for performing operations according to any of Aspects 11 to 20.

What is claimed is:

1. An apparatus for adjusting sensor parameters, the apparatus comprising:
at least one memory; and
at least one processor coupled to the at least one memory and configured to:
process an image of a sky to determine a position of a celestial body in the image;
determine an expected position of the celestial body;
compare the expected position of the celestial body and the determined position of the celestial body in the image; and
adjust parameters of a sensor based on the comparison.

2. The apparatus of claim 1, wherein the at least one processor is configured to:
generate an estimated image indicating the expected position of the celestial body; and
wherein the comparison of the expected position of the celestial body and the determined position of the celestial body in the image includes a comparison of the estimated image and the image of the sky.

3. The apparatus of claim 1, wherein the at least one processor is configured to:
determine to adjust the parameters of the sensor based on at least one of a temperature of the apparatus, a vibration of the apparatus, or a collision of the apparatus.

4. The apparatus of claim 1, wherein the at least one processor is configured to:
determine the expected position of the celestial body based on a time, a date, and a pose of the sensor.

5. The apparatus of claim 1, wherein the at least one processor is configured to:
determine the expected position of the celestial body based on high definition (HD) map data.

6. The apparatus of claim 1, wherein the sensor includes a camera.

7. The apparatus of claim 1, wherein the parameters of the sensor include at least one of a pitch, a roll, or a yaw of the sensor.

8. The apparatus of claim 1, wherein the at least one processor is configured to:
generate directions to a predetermined road; and
generate the image of the sky based on a location of the sensor on the predetermined road.

9. The apparatus of claim 8, wherein the at least one processor is configured to:
determine to adjust the parameters of the sensor based on the location of the sensor on the predetermined road.

10. The apparatus of claim 1, wherein the celestial body is at least one of a sun or a moon.

11. A method for adjusting sensor parameters, the method comprising:
processing an image of a sky to determine a position of a celestial body in the image;
determining an expected position of the celestial body;
comparing the expected position of the celestial body and the determined position of the celestial body in the image; and
adjusting parameters of a sensor based on the comparison.

12. The method of claim 11, further comprising:
generating an estimated image indicating the expected position of the celestial body; and
wherein the comparison of the expected position of the celestial body and the determined position of the celestial body in the image includes a comparison of the estimated image and the image of the sky.

13. The method of claim 11, further comprising:
determining to adjust the parameters of the sensor based on at least one of a temperature of the sensor, a vibration of the sensor, or a collision of the sensor.

14. The method of claim 11, further comprising:
determining the expected position of the celestial body based on a time, a date, and a pose of the sensor.

15. The method of claim 11, further comprising:
determining the expected position of the celestial body based on high definition (HD) map data.

16. The method of claim 11, wherein the sensor includes a camera.

17. The method of claim 11, wherein the parameters of the sensor include at least one of a pitch, a roll, or a yaw of the sensor.

18. The method of claim 11, further comprising:
generating directions to a predetermined road; and
generating the image of the sky based on a location of the sensor on the predetermined road.

19. The method of claim 18, further comprising:
determining to adjust the parameters of the sensor based on the location of the sensor on the predetermined road.

20. A non-transitory computer-readable medium having stored thereon instructions that, when executed by at least one processor, cause the at least one processor to:
process an image of a sky to determine a position of a celestial body in the image;
determine an expected position of the celestial body;
compare the expected position of the celestial body and the determined position of the celestial body in the image; and
adjust parameters of a sensor based on the comparison.
